(19) United States
(12) Patent Application Publication
(10) Pub. No.: US 2018/0137077 A1
(43) Pub. Date: May 17, 2018

(54) COMBINATION OF MOBILE ELECTRONIC DEVICE AND STORAGE MODULE

(71) Applicant: POWER 7 TECHNOLOGY CORP.(Shenzhen), Shenzhen (CN)

(72) Inventor: Mike CHEN, Shenzhen (CN)

(21) Appl. No.: 15/352,992

(22) Filed: Nov. 16, 2016

(51) Int. Cl. G06F 13/40; G06F 1/26; G06F 13/10; G06F 13/20; G06F 13/42; G06F 3/06

(52) U.S. Cl. CPC G06F 13/4068; G06F 1/26; G06F 13/102; G06F 13/20; G06F 2213/0042; G06F 3/0619; G06F 3/0647; G06F 3/067; G06F 13/4282

(57) ABSTRACT

A combination of mobile electronic device and storage module includes a mobile electronic device having a storage software build in a processor thereof for detecting data and a transmission interface connected to the processor for transmitting data, and a storage module including a docking interface electrically connectable with the transmission interface of the mobile electronic device, a microprocessor unit, a storage unit, a power supply unit for charging the mobile electronic device and a detection software program built in the microprocessor unit for detecting and recognizing the backup date, backup time, update date, tag name, and capacity size of the data being transmitted by the mobile electronic device and then storing the un-backed up data in the storage unit.

### FIELD OF THE INVENTION

The present invention relates to mobile electronic technology and more particularly, to a combination mobile electronic device and storage module, which comprises a mobile electronic device with a transmission interface, and a storage module for charging the mobile electronic device and enabling the mobile electronic device to back up data, wherein the storage module comprises a docking interface electrically connectable to the transmission interface of the mobile electronic device, a storage unit and a microprocessor with a built-in detection software program for detecting and identifying the backup date, backup time, update date, tag name, and capacity size of the data provided by the mobile electronic device and storing the un-backed up data in the storage unit.

### DESCRIPTION OF THE RELATED ART

With the rapid development of technology, many advanced electrical and electronic devices have been created for home application and for use outdoors. Among various electronic products, mobile electronic devices, such as tablet computers and smart phones are widely invited by people for the advantages of small size, light weight and high mobility. Further, a mobile electronic device can be connected to the Internet through wireless transmission. Through the Internet, mobile electronic devices can transport electronic messages from one network to another network around the world without time or space restrictions, not only won the favor of the younger generation, but also widely invited by the juvenile, middle-aged, old and other generations. Nowadays, almost everyone has one mobile phone. Mobile electronic devices are capable of carrying out communications, video call, video meeting or document data processing operations. With the popularity of mobile electronic devices and the utility and convenience of the Internet without borders, a lot of application software programs (Apps) have been continuously created for allowing mobile electronic devices to download data, pictures, photos, videos, software, music, games and other files from the Internet. However, the built-in memory capacity of a mobile electronic device can be insufficient for storing a large amount of downloaded data and electronic signals, and the management of a large amount of downloaded data and signals is not easy. Therefore, mobile electronic device users usually will use other mobile data storage devices, such as large-capacity flash drives, large-capacity hard drives or large-capacity mobile hard drives for backing up data. However, regular large-capacity mobile data storage devices can simply be used for storing and backing up data, they cannot analyze and identify the data to be backed up, resulting in the problem of backing up the data that has already been backed up and the problem of extended period of backup time and waste of labor.

Therefore, how to solve the problem of extended data backup time and waste of labor encountered during the use of a conventional mobile electronic device to back up data is the direction of improvement the relevant manufacturers need to study.

### SUMMARY OF THE INVENTION

The present invention has been accomplished under the circumstances in view. It is therefore the main object of the present invention to provide a combination of mobile electronic device and storage module, which can backup data and charge the mobile electronic device at the same time and has the advantages of high mobility, versatility and simplicity of operation simplicity.

To achieve this and other objects of the present invention, a combination of mobile electronic device and storage module comprises a mobile electronic device and a storage module. The mobile electronic device comprises a processor having built therein a storage software for data detection, and a transmission interface electrically connected to the processor for communication with a mating external interface for data transmission. The storage module is electrically connectable with the mobile electronic device, comprising at least one docking interface electrically connectable with the transmission interface of the mobile electronic device, a microprocessor unit, a detection software program built in the microprocessor unit for detecting data being transmitted from the mobile electronic device, a storage unit electrically connected to the microprocessor unit for storing data and backing up data being provided by the mobile electronic device, and a power supply unit electrically connected to the microprocessor unit for proving the microprocessor unit with the necessary working electricity and for charging the mobile electronic device.

According to another aspect of the present invention, the storage software of the processor mobile of the electronic device comprises a data browser operation interface, an application layer for realization of the operation function of the operation interface, a file system layer supporting FAT/NTFS/exFAT/Ext data system related storage protocols, a disk block operation protocol layer, a data transport protocol layer and a data storage layer.

According to still another aspect of the present invention, the storage module further comprises a housing that houses the at least one docking interface, the microprocessor unit, the storage unit and the power supply unit in such a manner that the at least one docking interface extends out of at least one side of the housing. Further, the housing comprises a mobile device holder outwardly extended from an outer wall thereof for holding the mobile electronic device. Preferably, the at least one docking interface is selected from the group of USB2.0, USB3.0, Micro USB and Mini USB. Further, the microprocessor unit can be a central processing unit, microprocessor or processor chip. Further, the built-in detection software program of the microprocessor unit of the storage module is adapted for detecting and recognizing the backup date, backup time, update date, tag name, and capacity size of the data being transmitted by the mobile electronic device, and then storing the un-backed up data in the storage unit. Thus, after connection between the storage module and the mobile electronic device, the storage module can backup data and charge the mobile electronic device at the same time.

Other advantages and features of the present invention will be fully understood by reference to the following specification in conjunction with the accompanying drawings.

### BRIEF DESCRIPTION OF THE DRAWINGS

FIG. 1 is a circuit block diagram of a combination mobile electronic device and storage module in accordance with the present invention.

FIG. 2 is a circuit block diagram of the storage software of the mobile electronic device of the combination mobile electronic device and storage module in accordance with the present invention.

FIG. 3 is an oblique top elevational view of the storage module of the combination mobile electronic device and storage module in accordance with the present invention.

FIG. 4 is an oblique top elevational view of the combination mobile electronic device and storage module in accordance with the present invention.

### DETAILED DESCRIPTION OF THE PREFERRED EMBODIMENT

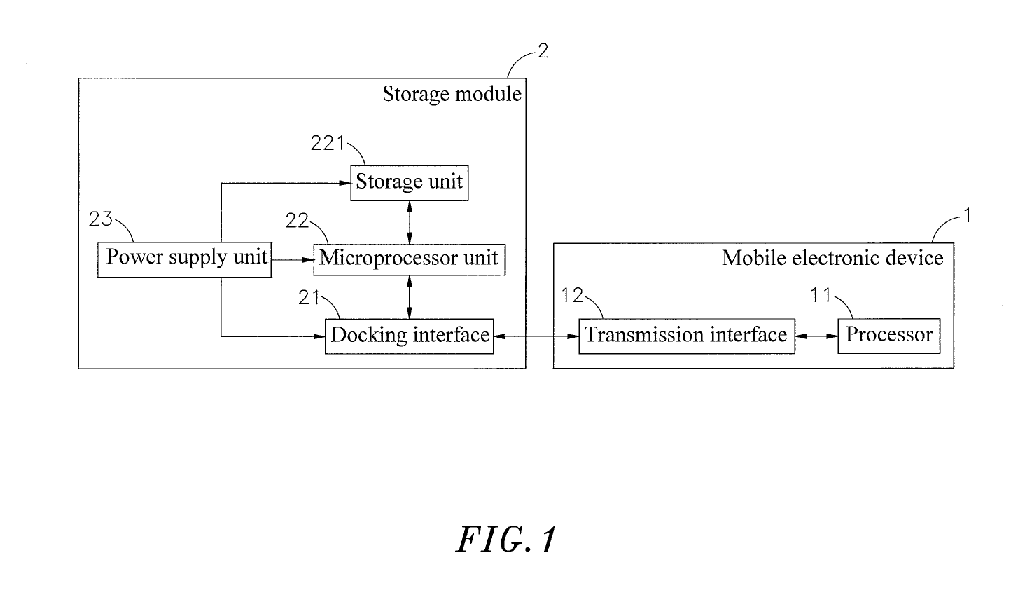

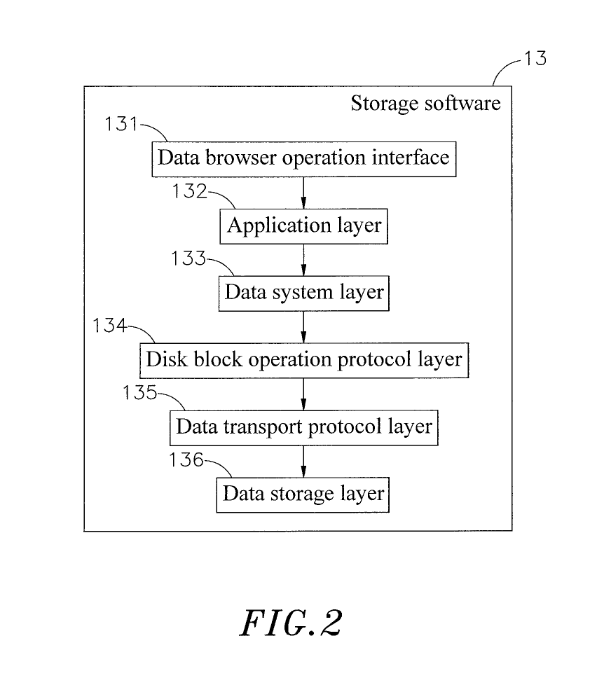

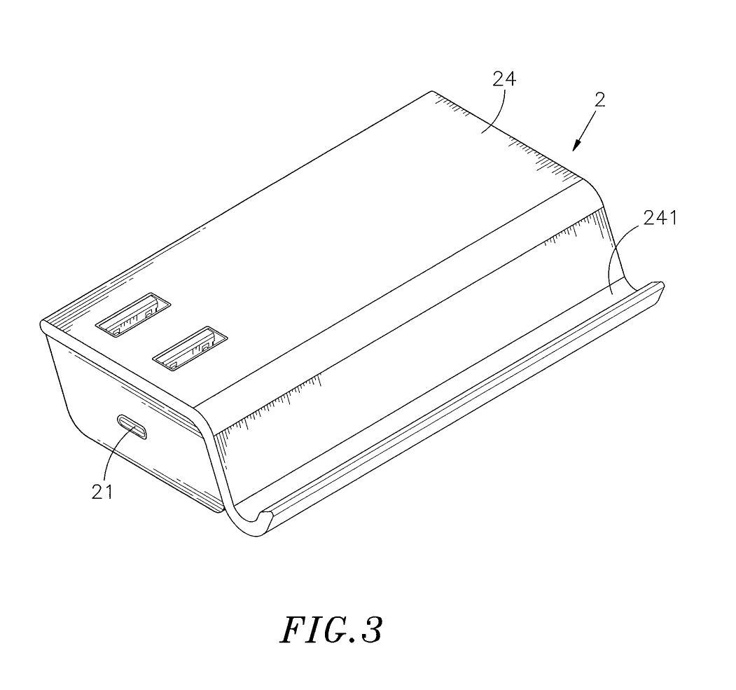

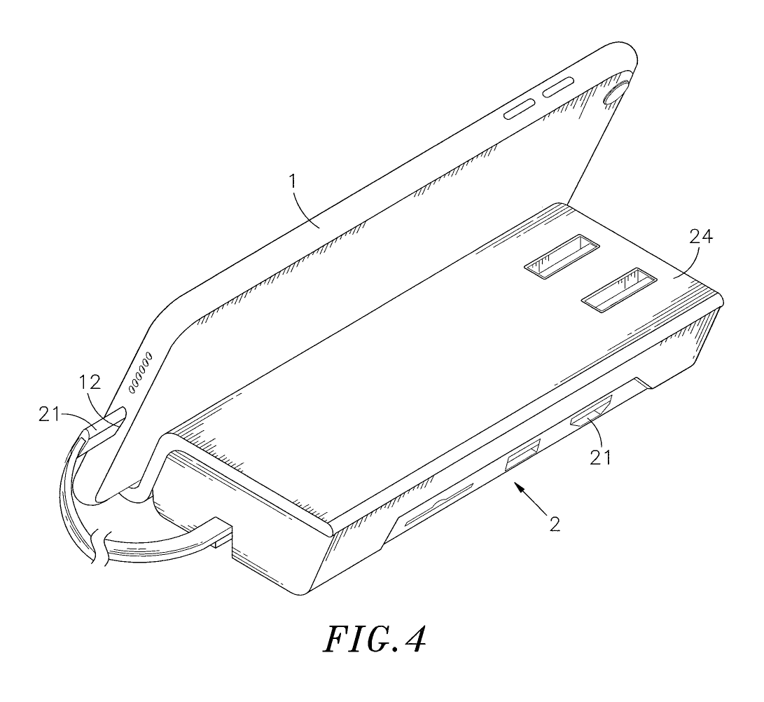

Referring to FIGS. 1-4, a combination mobile electronic device and storage module in accordance with the present invention is shown. The combination mobile electronic device and storage module comprises a mobile electronic device 1 and a storage module 2.

The mobile electronic device 1 comprises a processor 11, and a transmission interface 12 electrically connected to the processor 11. The processor 11 has built therein a storage software 13. The storage software 13 comprises a data browser operation interface 131, an application layer 132 for realization of the operation function of the data browser operation interface 131, a file system layer 133 supporting FAT/NTFS/exFAT/Ext data system related storage protocols, a disk block operation protocol layer 134, a data transport protocol layer 135 and a data storage layer 136. Through respective layers, the storage software 13 reads, writes, modifies, creates or deletes data in the data storage layer 136.

The storage module 2 comprises at least one docking interface 21, a microprocessor unit 22, a storage unit 221, a power supply unit 23, and a housing 24 that houses the docking interface 21, the microprocessor unit 22, the storage unit 221 and the power supply unit 23. The at least one docking interface 21 extends out of at least one side of the housing 24. The housing 24 comprises a mobile device holder 241 extended from an outer wall thereof. The docking interface 21 is electrically coupled to the microprocessor unit 22. The microprocessor unit 22 has built therein a detection software program, and is electrically connected with the power supply unit 23 and the storage unit 221.

In actual application, connect the transmission interface 12 of the mobile electronic device 1 to the docking interface 21 of the storage module 2, and then operate the mobile electronic device 1 for enabling the storage data or electronic signal to be transmitted from the data storage layer 136 of the storage software 13 of the processor 11 through the transmission interface 12 to the docking interface 21 of the storage module 2 so that the built-in detection software program of the microprocessor unit 22 can detect and recognize the transmitted data or electronic signal and then determine the backup date, backup time, update date, tag name, and capacity size of the transmitted data or electronic signal, and then store the un-backed up data or electronic signal in the storage unit 221, enabling the mobile electronic device 1 to achieve data backup. Thus, connecting the storage module 2 to the mobile electronic device 1 achieves the work or charging the mobile electronic device 1 and the work of data backup.

Further, the mobile electronic device 1 can be a smart phone, tablet computer, personal digital assistant or notebook computer; the processor 11 of the mobile electronic device 1 can be a central processing unit (CPU), microprocessor or processor chip; the transmission interface 12 of the mobile electronic device 1 comprises a processor 11 can be USB2.0, USB3.0, Micro USB or Mini USB.

Further, the storage module 2 can be a hard disk drive (HDD), solid-state drive (SSD), secure digital (SD) memory card, T-flash memory card, USB flash drive, embedded multimedia card (eMMC) or Nand Flash memory; the docking interface 21 of the storage module 2 can be a USB2.0, USB3.0, Micro USB or Mini USB; the microprocessor unit 22 of the storage module 2 can be a central processing unit (CPU), microprocessor or processor chip having a detection software program built therein for detecting and identifying the backup date, backup time, update date, tag name, and capacity size of the data or electronic signal received from the mobile electronic device 1 and then mating with the backed up data content in the storage unit 221 so as to exclude the data content that has been backed up and then to store the un-backed up data in the storage unit 221. This method greatly shortens the time to duplicate all the data, saving much time and labor. Further, connecting the storage module 2 to the mobile electronic device 1 can backup data and charge the mobile electronic device 1 at the same time.

Further, the storage software 13 built in the processor 11 of the mobile electronic device 1 can be an iOS/Android certified data storage system application software program for transmitting storing and reading data or electronic signal between the mobile electronic device 1 and the storage module 2.

Further, the storage module 2 can transmit power supply from the power supply unit 23 through the docking interface 21 to the transmission interface 12 to charge the mobile electronic device 1. In application, the user can position the mobile electronic device 1 in the mobile device holder 241 of the housing 24, enabling the mobile electronic device 1 to get power supply from the storage module 2 for working. Further, the power supply unit 23 of the storage module 2 can be a lithium battery pack, dry battery pack, rechargeable battery pack or any other power supply means capable of providing DC or AC electricity for charging the mobile electronic device 1.

In conclusion, the invention provides a combination of mobile electronic device and storage module consisting of a mobile electronic device and storage module. The mobile electronic device has a storage software build in a processor thereof for detecting data, and a transmission interface connected to the processor for transmitting data. The storage module comprises a docking interface electrically connectable with the transmission interface of the mobile electronic device, a microprocessor unit, a storage unit, a power supply unit for charging the mobile electronic device and a detection software program built in the microprocessor unit for detecting and recognizing the backup date, backup time, update date, tag name, and capacity size of the data being transmitted by the mobile electronic device and then storing the un-backed up data in the storage unit. Thus, after connection between the storage module and the mobile electronic device, the storage module can backup data and charge the mobile electronic device at the same time.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A combination of mobile electronic device and storage module, comprising:
a mobile electronic device comprising a processor having built therein a storage software for data detection, and a transmission interface electrically connected to said processor for communication with a mating external interface for data transmission; and
a storage module electrically connectable with said mobile electronic device, said storage module comprising at least one docking interface electrically connectable with said transmission interface of said mobile electronic device, a microprocessor unit, a detection software program built in said microprocessor unit for detecting data being transmitted from said mobile electronic device, a storage unit electrically connected to said microprocessor unit for storing data and backing up data being provided by said mobile electronic device and a power supply unit electrically connected to said microprocessor unit for proving said microprocessor unit with the necessary working electricity and for charging said mobile electronic device.

2. The combination mobile electronic device and storage module as claimed in claim 1, wherein said storage software of said processor mobile of said electronic device comprises a data browser operation interface, an application layer for realization of the operation function of said operation interface, a file system layer supporting FAT/NTFS/exFAT/Ext data system related storage protocols, a disk block operation protocol layer, a data transport protocol layer and a data storage layer.

3. The combination mobile electronic device and storage module as claimed in claim 1, wherein said storage module further comprises a housing that houses said at least one docking interface, said microprocessor unit, said storage unit and said power supply unit in such a manner that said at least one docking interface extends out of at least one side of said housing, said housing comprising a mobile device holder outwardly extended from an outer wall thereof for holding said mobile electronic device; said at least one docking interface is selected from the group of USB2.0, USB3.0, Micro USB and Mini USB; said microprocessor unit is a central processing unit, microprocessor or processor chip; the built-in detection software program of said microprocessor unit of said storage module is adapted for detecting and recognizing the backup date, backup time, update date, tag name, and capacity size of the data being transmitted by said mobile electronic device, and then storing the un-backed up data in said storage unit.
